(19) United States
(12) Patent Application Publication
(10) Pub. No.: US 2003/0076309 A1
(43) Pub. Date: Apr. 24, 2003

(54) Computerized apparatus with a touch pen adapted for wireless communications

(75) Inventor: Wei-Pin Chuang, Taipei City (TW)

Correspondence Address: FOLEY AND LARDNER, SUITE 500, 3000 K STREET NW, WASHINGTON, DC, 20007, US

(73) Assignee: COMPAL ELECTRONICS, INC.

(21) Appl. No.: 09/996,746

(22) Filed: Nov. 30, 2001

(30) Foreign Application Priority Data
Oct. 23, 2001 (TW) 90218099

(51) Int. Cl. G09G 5/00

(52) U.S. Cl. 345/179

(57) ABSTRACT

A computerized apparatus includes a circuit module mounted in a housing and coupled electrically to a touch control panel that is mounted on the housing. The circuit module has a first contact unit registered with an insert hole formed in the housing. A touch pen is mounted removably on the housing, and has a second contact unit extending radially and outwardly from a conductive core that extends from a first end portion to a second end portion of the touch pen. The first end portion is formed as a touch tip for operating the touch control panel when the touch pen is removed from the housing. The first contact unit establishes electrical contact with the second contact unit when the touch pen is extended into the housing via the insert hole such that the circuit module is capable of receiving and transmitting a wireless signal from and to the conductive core.

### BACKGROUND OF THE INVENTION

1. Field of the Invention

The invention relates to a computerized apparatus with a touch pen, more particularly to a computerized apparatus with a touch pen that is adapted for wireless communications.

2. Description of the Related Art

The design of a portable computerized apparatus, such as a personal digital assistant or a handheld computer, has a current trend toward integration with wireless communications. In view of aesthetic considerations, an antenna for wireless communications is generally designed to be built in a conventional computerized apparatus. However, the concealed antenna generally suffers from inferior wireless transmission and reception.

### SUMMARY OF THE INVENTION

Therefore, the object of the present invention is to provide a computerized apparatus with a touch pen that can serve as an antenna for wireless communications.

According to the present invention, a computerized apparatus comprises:

a housing formed with an insert hole;

a touch control panel mounted on the housing;

a circuit module mounted in the housing and coupled electrically to the touch control panel, the circuit module having a first contact unit registered with the insert hole in the housing; and

a touch pen mounted removably on the housing and having a first end portion, a second end portion opposite to the first end portion, and a conductive core that extends from the first end portion to the second end portion, the first end portion being formed as a touch tip for operating the touch control panel when the touch pen is removed from the housing, the touch pen further having a second contact unit that extends radially and outwardly from the conductive core;

the first contact unit establishing electrical contact with the second contact unit when the touch pen is extended into the housing via the insert hole such that the circuit module is capable of receiving and transmitting a wireless signal from and to the conductive core.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of a computerized apparatus according to this invention;

FIG. 2 is a partly schematic fragmentary sectional view of the first preferred embodiment;

FIG. 3 is a perspective view showing the second preferred embodiment of a computerized apparatus according to this invention; and

FIG. 4 is a perspective view showing the third preferred embodiment of a computerized apparatus according to this invention.

### DETAILED DESCRIPTION OF THE PREFERRED EMBODIMENTS

Before the present invention is described in greater detail, it should be noted that like elements are denoted by the same reference numerals throughout the disclosure.

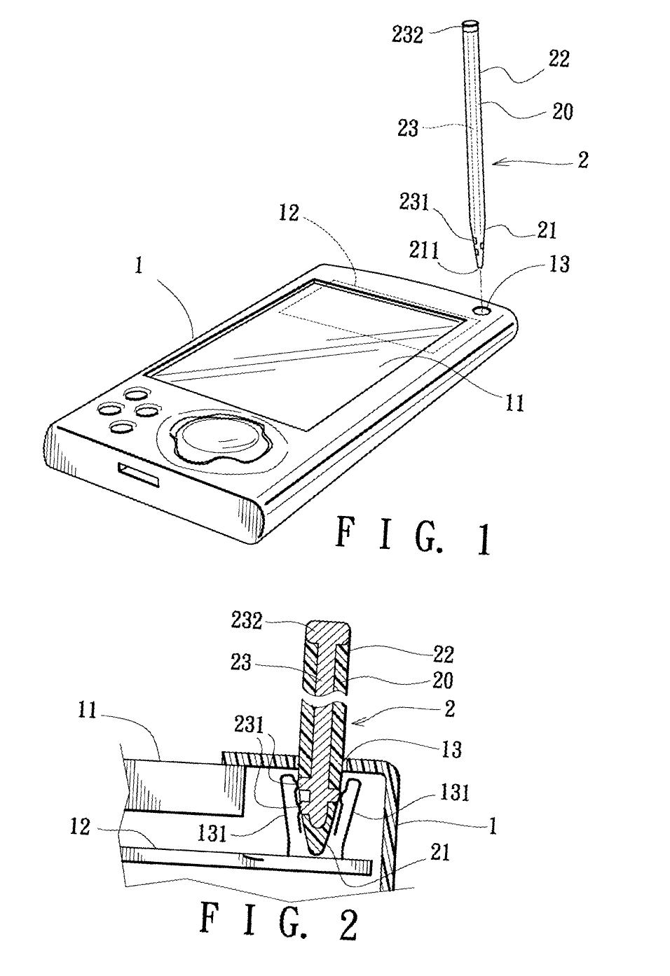

Referring to FIGS. 1 and 2, the first preferred embodiment of a computerized apparatus according to the present invention is shown to be embodied in a personal digital assistant that includes a housing 1, a touch control panel 11, a circuit module 12, and a touch pen 2.

The housing 1 is formed with an insert hole 13. The touch control panel 11 is mounted on the housing 1. The circuit module 12 is mounted in the housing 1 and is coupled electrically to the touch control panel 11.

The circuit module 12 has a first contact unit registered with the insert hole 13 in the housing 1. In this embodiment, the first contact unit includes a pair of conductive resilient pieces 131, as shown in FIG. 2.

The touch pen 2 is mounted removably on the housing 1, and has a first end portion 21, a second end portion 22 opposite to the first end portion 21, and a conductive core 23 that extends from the first end portion 21 to the second end portion 22. In this embodiment, the conductive core 23 is made of metal and is enclosed by a plastic barrel 20. The first end portion 21 is formed as a touch tip 211 for operating the touch control panel 11. The conductive core 23 has a cap end portion 232 exposed from the barrel 20 at the second end portion 22 of the touch pen 2. The touch pen 2 further has a second contact unit 231 that is formed on the first end portion 21 and that extends radially and outwardly from the conductive core 23 through the barrel 20. As such, the conductive resilient pieces 131 contact the second contact unit 231, and clamp the first end portion 21 of the touch pen 2 therebetween when the first end portion 21 of the touch pen 2 is extended into the housing 1 via the insert hole 13.

Therefore, the first contact unit establishes electrical contact with the second contact unit 231 when the touch pen 2 is extended into the housing 1 via the insert hole 13 such that the circuit module 12 is capable of receiving and transmitting a wireless signal from and to the conductive core 23.

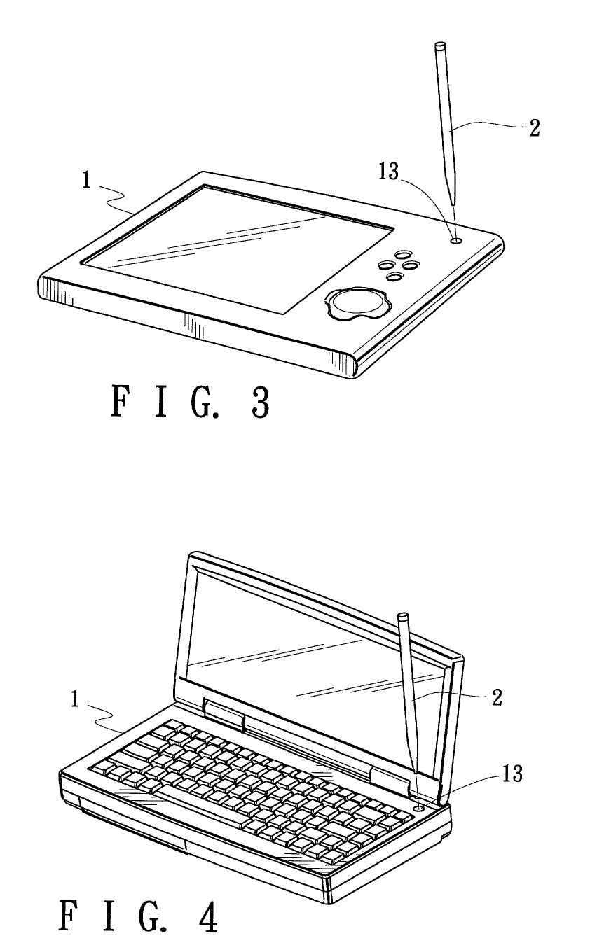

FIGS. 3 and 4 respectively illustrate the second and third preferred embodiments of a computerized apparatus according to this invention, which are modifications of the first preferred embodiment. The second and third preferred embodiment are respectively embodied in a tablet computer and a handheld computer.

It is noted that, due to the presence of the conductive core 23, the touch pen 2 can serve as an antenna for wireless communications when the touch pen 2 is extended into the housing 1 via the insert hole 13. The object of the invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A computerized apparatus, comprising:
a housing formed with an insert hole;
a touch control panel mounted on said housing;
a circuit module mounted in said housing and coupled electrically to said touch control panel, said circuit module having a first contact unit registered with said insert hole in said housing; and
a touch pen mounted removably on said housing and having a first end portion, a second end portion opposite to said first end portion, and a conductive core that extends from said first end portion to said second end portion, said first end portion being formed as a touch tip for operating said touch control panel when said touch pen is removed from said housing, said touch pen further having a second contact unit that extends radially and outwardly from said conductive core;
said first contact unit establishing electrical contact with said second contact unit when said touch pen is extended into said housing via said insert hole such that said circuit module is capable of receiving and transmitting a wireless signal from and to said conductive core.

2. The computerized apparatus as claimed in claim 1, wherein said second contact unit is formed on said first end portion of said touch pen so as to establish electrical contact with said first contact unit when said first end portion of said touch pen is extended into said housing via said insert hole.

3. The computerized apparatus as claimed in claim 2, wherein said first contact unit includes a pair of conductive resilient pieces that contact said second contact unit and that clamp said first end portion of said touch pen therebetween when said first end portion of said touch pen is extended into said housing via said insert hole.
